(19) United States
(12) Patent Application Publication
(10) Pub. No.: US 2007/0061253 A1
(43) Pub. Date: Mar. 15, 2007

(54) Method and article for soliciting and processing charitable donations

(76) Inventor: Christine Nociti, Riverton, NJ (US)

Correspondence Address: CATALINA + ASSOCIATES, LLC, 167 AVENUE AT THE COMMON, SUITE 9, SECOND FLOOR, SHREWSBURY, NJ, 07702, US

(21) Appl. No.: 11/519,423

(22) Filed: Sep. 12, 2006

Related U.S. Application Data
(60) Provisional application No. 60/716,305, filed on Sep. 12, 2005.

(51) Int. Cl. G06Q 40/00

(52) U.S. Cl. 705/39

(57) ABSTRACT

A method and article for soliciting and processing charitable donations from account holders of a financial institution are disclosed. In one embodiment, the article is a portion of a package mailed by the financial institution to the account holders and includes authorization to charge a donation to an account holder's account with the financial institution. The article may be designed as a separate document, a portion of a document included in the package, or a detachable part of a sealing flap of a return envelope addressed to the financial institution.

### CROSS-REFERENCE TO RELATED APPLICATIONS

This application claims benefit of U.S. provisional patent application Ser. No. 60/716,305 filed Sep. 12, 2005, which is herein incorporated by reference.

### FIELD OF THE INVENTION

The present inventions generally relate to the field of fundraising using private donations and, in particular, to direct-mail based methods and articles for soliciting and processing charitable donations.

### BACKGROUND OF THE INVENTION

The present invention generally relates to direct-mail based methods and articles for soliciting and processing private donations and, in particular, private monetary donations to legitimate charitable organizations. Presently, such donations are typically solicited by a respective charitable organization by mailing repetitive solicitations to a pool of potential donors or other direct or indirect means.

Efficiency of such fundraising scheme strongly depends on accuracy, relevance, and broadness of mailing lists used by the charitable organization and, conventionally, is relatively low. Furthermore, the charitable organizations carry ever-increasing costs of direct-mail based marketing campaigns, including costs associated with assembling the mailing lists, mailing the solicitations, and processing the received donations.

As such, despite the considerable effort in the art devoted to development of means for soliciting and processing charitable donations, further improvements would be desirable.

### SUMMARY OF THE INVENTION

One aspect of the present invention provides a method for soliciting and processing monetary donations to a legitimate charitable organization from account holders of a financial institution, such as a bank, a brokerage, a mutual fund company, a credit or charge card company, a trade corporation issuing credit or charge cards, a publicly traded company, and the like.

In one embodiment, the method comprises the steps of electing at a financial institution a qualifying charitable organization, including in a package mailed by the financial institution to an account holder an article containing a template of authorization for the financial institution to charge a donation to the charitable organization to an account of the account holder with the financial institution, and processing the donations made by the account holders using these articles. The packages mailed by the financial institution include at least one of a financial statement, a bill, a refund, a promotion, an information material of the financial institution, or an information material of the charitable organization. In one particular embodiment, the article is a detachable portion of a sealing flap of the return envelope, a separate sheet, or a portion of a document included in the package mailed to the account holder.

Another aspect of the present invention is a return envelope provided by a financial institution to an account holder of the financial institution. The return envelope comprises a detachable portion containing a template of authorization to charge a donation to a charitable organization to an account of the account holder with the financial institution.

In one embodiment, the template contains at least some of the following data fields, among possible others: a check box allowing the account holder to confirm a desire to make the donation, a declaration of the account holder authorizing the financial institution to charge the donation, an amount of the donation, an account number data field, a signature block, a date block, and an identification code of the detachable portion. In other embodiments, the template may also contain a logo or a name of the financial institution or charitable organization, as well as fields including suggested amounts of the donation and check boxes for indicating the selected amounts of the donation.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 is a flow diagram illustrating a method for soliciting and processing charitable donations in accordance with one embodiment of the present invention;

FIG. 2 is high-level, schematic diagram depicting an article for soliciting and processing charitable donations in accordance with one embodiment of the method of FIG. 1;

FIG. 3 is high-level, schematic diagram depicting an article for soliciting and processing charitable donations in accordance with another embodiment of the method of FIG. 1; and

FIGS. 4A-4C are high-level, schematic diagrams depicting front, rear, and side views, respectively, of a return envelope adapted for soliciting and processing charitable donations using of the method of FIG. 1 in accordance with yet another embodiment of the present invention.

To facilitate understanding, identical reference numerals have been used, where possible, to designate identical elements that are common to the figures, except that suffixes may be added, when appropriate, to differentiate such elements. The images in the drawings are simplified for illustrative purposes and are not depicted to scale.

The appended drawings illustrate exemplary embodiments of the invention and, as such, should not be considered as limiting the scope of the invention that may admit to other equally effective embodiments.

### DETAILED DESCRIPTION

The present invention generally relates to a method and article for soliciting and processing donations to legitimate charitable organizations from account holders of financial institutions.

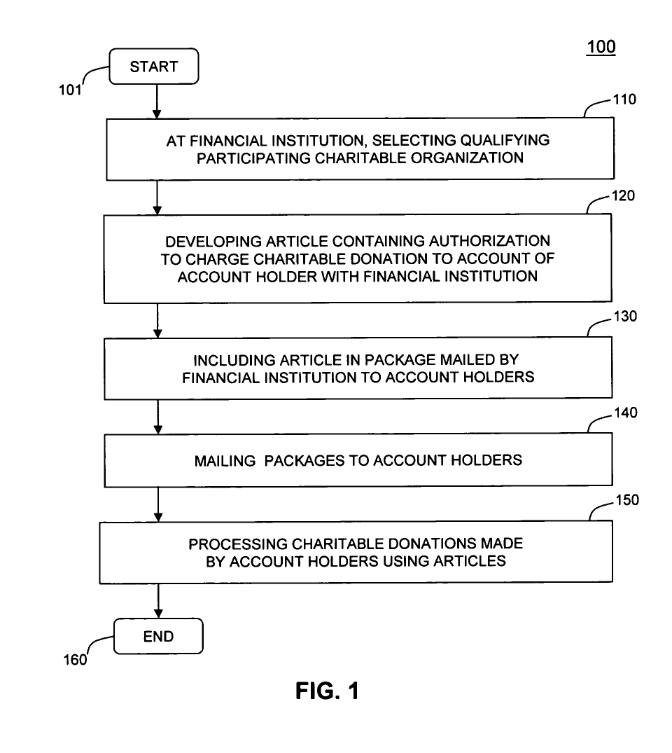

FIG. 1 is a flow diagram illustrating a method 100 for soliciting and processing charitable donations in accordance with one embodiment of the present invention. The method 100 includes processing steps performed to solicit and process the donations made to a charitable organization by account holders of a financial institution. In some embodiments, the method steps are performed in the depicted order. In alternate embodiments, at least two of these steps or portions thereof may be performed in a different order or contemporaneously.

The term “charitable organization” herein refers to entities qualifying to such a status and in compliance with applicable regulations as defined by the Internal Revenue Service, and the term “financial institution” herein is broadly used in reference to entities having financial relations with retail clientele in a form of individual accounts with each of their clients. Examples of such financial institutions include, but are not limited to, banks, brokerages, mutual fund companies, credit or charge card companies, trade corporation issuing credit or charge cards, publicly traded companies, utility companies, and the like. Depending on a type of a specific financial institution, an account holder may have a customer, investor, shareholder, or a combination thereof relationship with the respective financial institution.

The method 100 starts at step 101 and proceeds to step 110. At step 110, a financial institution enters into a business agreement with a charitable organization of its choice. In particular, the charitable organization may be selected from a list of the qualifying charitable organizations that seek monetary donations from account holders of the financial institution. The charitable organization entering into the agreement with the financial institution is referred to hereafter as a participating charitable organization.

The terms of the business agreement between the financial institution and the charitable organization may include, for example, a commitment on part of the charitable organization to absorb, at least partially, costs of preparing articles used for soliciting the charitable donations from the account holders, costs associated with mailing the articles to the respective account holders, or cost of processing the received donations. Furthermore, the charitable organization may select to deposit or keep the donations or other funds in its accounts with the financial institution for a pre-determined duration of time, among other terms beneficial to the financial institution or the charitable organization.

At step 120, the financial institution develops an article adapted for soliciting donations to the participating charitable organization from the account holders and for processing of the donations. The article may be a separate document, as well as an integral part or detachable portion of other document that is intended for mailing to the account holder by the financial institution. In one preferred embodiment, the article contains a template of authorization for the financial institution to charge a donation to the charitable organization to an account of the account holder with the financial institution.

In one embodiment, the template contains a plurality of pre-printed data fields, including at least a portion of such the data fields as a check box allowing an account holder to confirm a desire to make a donation, a declaration of the account holder authorizing the financial institution to charge the donation to their account with the financial institution, an amount of the donation data field, an account number data field, a signature or initials block, a date block, or an article identification code (AIC) data field. The account number data field may contain the account number of the account holder or, alternatively, a sufficient for identification purposes portion of the account number. The AIC data field is a service field that, at the financial institution, may be used for statistical or marketing analysis purposes or for automating portions of processing the received donations.

Generally, selection of specific data fields for inclusion in the article depends on a design format of the latter. For example, the article designed as a separate document or a detachable portion of other document, may contain all of these data fields. Alternatively, at least some redundant data fields may be omitted or simplified in the article designed as an integral part of other document already having such data fields or positively reciting their content.

In alternate embodiments, the article may additionally contain at least some of the following data fields: (i) a data field including a logo or a name of the financial institution, or both, (ii) a data field including a logo or a name of the charitable organization, or both, or (iii) one or more data fields each including a suggested amount of the donation and a check box for indicating the selected amount of the donation.

At step 130, the financial institution assembles packages that the financial institution periodically or occasionally mails to the account holders. Examples of periodically mailed packages include monthly, quarterly, or year-end personalized financial statements mailed to the account holders by banks, brokerages, mutual find and credit or charge card companies. Accordingly, examples of occasionally mailed packages include packages containing proxy documents, announcements, and the like.

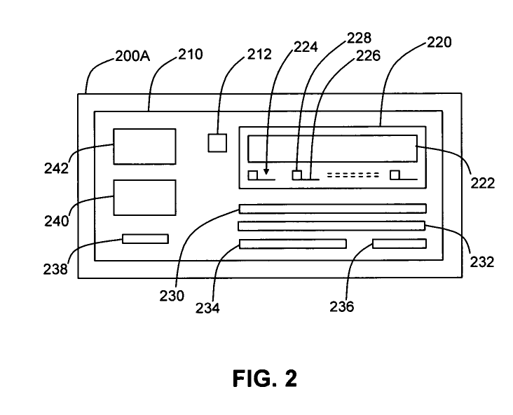

Generally, as a part of the packages and courtesy to their account holders, the financial institution provides pre-printed self-addressed return envelopes, which the account holders may use for submitting remittances, payments, proxy cards, and the like return documents. In one particular embodiment, the article is designed as a detachable portion of a sealing flap of the return envelope (discussed in detail below in reference to FIGS. 2A-2C).

In one embodiment, each of the packages includes the referred to above article along with at least one of a financial statement, a bill, a refund, a promotion, an information material of the financial institution, or an information material of the at least one charitable organization. In alternate embodiments, the package may include only the article or the article and return envelope. In some embodiments, the financial institution, charitable organization, or third parties establish one or more prizes to the account holders including the articles in return mail to the financial institution. Such prizes are awarded regardless of an amount of the donation, if any.

At step 140, the packages including the article adapted for soliciting and processing donations to the charitable organization are mailed to the account holders of the financial institution.

At step 150, the financial institution processes return mail received from the account holders and, in particular, processes donations to the charitable organization, which are made using the articles included in the packages mailed to the account holders at the preceding step of the method 100.

In one embodiment, at the financial institution, processing of the donations to the charitable organization includes the steps of locating the articles in the return mail, validating the donations (e.g., verifying legitimacy and correctness of executed authorizations for charging the respective account), debiting amounts of validated donations from accounts of the respective donors (i.e., account holders), crediting amounts of the validated donations to an account (or accounts) of the charitable organization with the financial institution, notifying senders of invalidated articles about errors found in their submissions, and the like. As discussed above in reference to step 110, the financial institution and charitable organization may share, at least partially, the costs of processing the donations.

Upon completion of step 150, at step 160, the method 100 ends.

FIG. 2 is high-level, schematic diagram depicting an article 200A adapted for soliciting and processing charitable donations in accordance with one embodiment of the method 100 of FIG. 1. The article 200A is designed as a separate document and, in the depicted embodiment, illustratively includes a template section (or template) 210 having a check box 212, a request region 220, an account holder name data field 230, an account number data field 232, a signature block 234, a date block 236, an AIC data field 238, a data field 240 including a logo and/or a name of the financial institution, and a data field 242 including a logo and/or a name of the charitable organization. The request region 220 contains a data field 222 including a declaration from the account holder authorizing the financial institution to charge a donation to a charitable organization to the account of the account holder with the financial institution and the amount of the donation or, optionally, one or more data fields 224 each including a suggested amount 226 of the donation and a check box 228 for indicating the selected amount of the donation. Together, the data fields 244 form a data field for an amount of the donation made by the account holder.

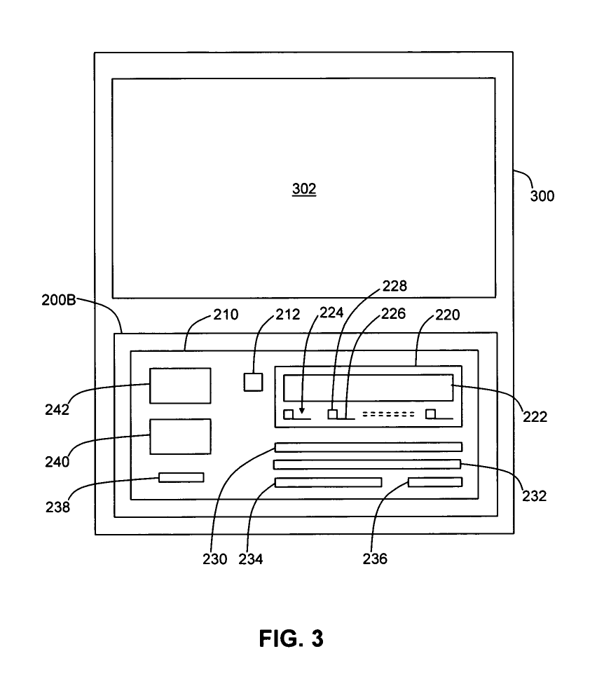

FIG. 3 is high-level, schematic diagram depicting an article 200B for soliciting and processing charitable donations in accordance with another embodiment of the method 100 of FIG. 1. In this embodiment, the article is a pre-printed portion of a document 300, such as, for example, a financial statement, a bill, a refund, and the like.

As discussed above in reference to step 120, some redundant data fields in the article 200B may be omitted or simplified. For example, when the document 300 contains fields containing a name and a signature of the account holder and includes the account number and date of signing the document, in the article 200B the signature block 234 may optionally be modified to require from the account holder only to initialize the article, while at least some of the data fields 230, 232, 234, or 236 may optionally be omitted (not shown).

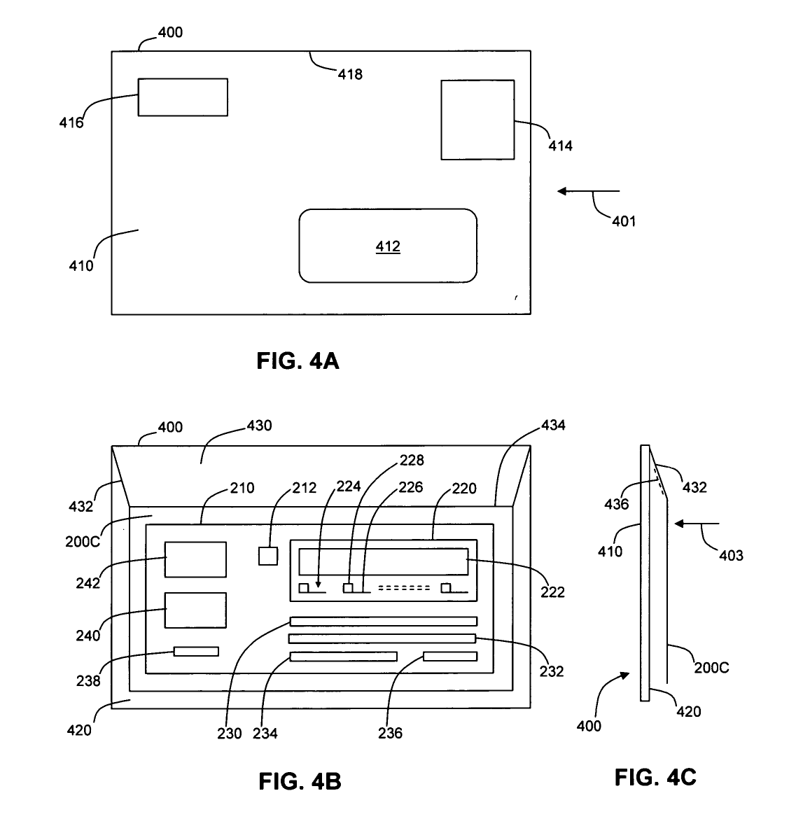

FIGS. 4A-4C are high-level, schematic diagrams depicting front, rear, and left side views, respectively, of a return envelope 400 adapted for soliciting and processing charitable donations using the method 100 of FIG. 1 in accordance with yet another embodiment of the present invention. A view in FIG. 4C is taken in the direction of arrow 401 in FIG. 4A, and a view in FIG. 4B is taken in the direction of arrow 403 in FIG. 4C, respectively. To best understand the invention, the reader should simultaneously refer to FIGS. 4A-4C.

The return envelope 400 generally comprises a front panel 410, a rear panel 420, and a sealing flap 430. Referring to FIG. 4A, the front panel 410 includes an addressing region 412 containing, for example, a pre-printed address of the financial institution or a transparent window for displaying the address pre-printed on the enclosed document, a region 414 for affixing a post stamp or carrying an appropriate authorization for postage-free, on part of a sender, delivery of the envelope 400 to the financial institution, and a region 416 for a mailing address of the sender. Conventionally, the regions 414 and 416 are disposed along an upper edge 418 of the envelope.

Referring to FIG. 4C, the sealing flap 430 contains a panel 432 attached to the front panel 410 and an article 200C detachably connected to the panel 432 along a line 434. In one embodiment, the panel 432 is an extension of the front panel 410, which is folded about the edge 418 of the front panel 410. An inner surface of the panel 432 contains a layer of a sealant 436 that, when activated, may affix the panel 432 to the rear panel 420, thus sealing the envelope 400 and protecting its contents.

Detachable connection between the panel 432 and the article 200C may be provided by, for example, perforating or otherwise mechanically weakening the sealing flap 430 along the line 434. The sealing flap 430 or the article 200C may further contain mailing instructions for the sender (e.g., account holder). In particular, the sender may be instructed to detach the article 200C from the panel 432 before sealing the envelope 400 or, if the account holder makes a donation to the charitable organization using the article 200C, to place the executed and signed article in the envelope 400 together with other intended submissions to the financial institution, and then seal the envelope.

Although the invention herein has been described with reference to particular illustrative embodiments, it is to be understood that these embodiments are merely illustrative of the principles and applications of the present invention. Therefore, numerous modifications may be made to the illustrative embodiments and other arrangements may be devised without departing from the spirit and scope of the present invention, which is defined by the appended claims.

What is claimed is:

1. A method for soliciting and processing charitable donations, comprising:
(a) selecting at a financial institution a charitable organization soliciting the donations from account holders of the financial institution;
(b) developing articles each including a template of authorization for the financial institution to charge a donation to the charitable organization to an account of an account holder of the financial institution;
(c) including the articles in packages mailed by the financial institution to the account holders; and
(d) processing the donations made by the account holders using the articles.

2. The method of claim 1, wherein the financial institution is a bank, a brokerage, a mutual fund company, a credit or charge card company, a trade corporation issuing credit or charge cards to its customers, a publicly traded company, or a utility company.

3. The method of claim 1, wherein each of the packages further includes at least one of a financial statement, a bill, a refund, a promotion, an information material of the financial institution, an information material of the charitable organization, or a return envelope.

4. The method of claim 1, wherein the article is a detachable portion of a sealing flap of the return envelope, a separate sheet, or a portion of a document included in the package.

5. The method of claim 1, wherein the template contains at least a portion of the following pre-printed data fields:
a check box allowing the account holder to confirm a desire to make the donation;
a declaration of the account holder authorizing the financial institution to charge the donation;
an amount of the donation data field;
an account number data field;
a signature or initials block;
a date block; and
an article identification code data field.

6. The method of claim 5, wherein at least a portion of an account number of the account of the account holder is pre-printed in the account number data field.

7. The method of claim 5, wherein the template further comprises at least one of the following pre-printed data fields:
a data field including a logo or a name of the financial institution, or both;
a data field including a logo or a name of the charitable organization, or both;
one or more data fields each including a suggested amount of the donation and a check box for indicating the selected amount of the donation.

8. The method of claim 1, wherein the charitable organization at least partially absorbs costs of developing the article, assembling the packages, mailing the packages to the account holders, or processing the return mail from the account holders.

9. The method of claim 1, wherein the charitable organization accumulates the donations on one or more accounts serviced by the financial institution.

10. The method of claim 1, wherein the financial institution, the charitable organization, or a third party establish one or more prizes to the account holders including the articles, regardless of an amount of the donation, in return mail to the financial institution.

11. The method of claim 1, wherein the charitable organization is a charitable organization qualifying under and in compliance with regulations of the Internal Revenue Service.

12. A return envelope provided by a financial institution to an account holder of the financial institution, the return envelope comprising a detachable article including a template of authorization for the financial institution to charge a donation to a charitable organization to an account of the account holder with the financial institution.

13. The return envelope of claim 12, wherein the detachable article is portion of a sealing flap of the return envelope.

14. A return envelope of claim 12, wherein the template contains at least a portion of the following pre-printed data fields:
a check box allowing a account holder to confirm a desire to make the donation;
a declaration of the account holder authorizing the financial institution to charge the donation;
an amount of the donation data field;
an account number data field;
a signature block;
a date block; and
an article identification code data field.

15. The return envelope of claim 14, wherein at least a portion of an account number of the account of the account holder is pre-printed in the account number data field.

16. The return envelope of claim 14, wherein the template further comprises at least one of the following pre-printed data fields:
a data field including a logo or a name of the financial institution, or both;
a data field including a logo or a name of the charitable organization, or both;
one or more data fields each including a suggested amount of the donation and a check box for indicating the selected amount of the donation.

17. The return envelope of claim 12, wherein the financial institution is a bank, a brokerage, a mutual fund company, a credit or charge card company, a trade corporation issuing credit or charge cards, or a publicly traded company.

18. The return envelope of claim 12, wherein said return envelope is a portion of a package further including at least one of a financial statement, a bill, a refund, a promotion, an information material of the financial institution, or an information material of the charitable organization.

19. The return envelope of claim 12, wherein said return envelope is a postage-prepaid return envelope.
